(19) United States
(12) Patent Application Publication
(10) Pub. No.: US 2007/0083273 A1
(43) Pub. Date: Apr. 12, 2007

(54) Multi-function portable device for electronic processors

(75) Inventor: Gissi Ruggero, Curnasco Di Treviolo (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: Eutron Infosecurity S.R.L., Curnasco diTreviolo (IT)

(21) Appl. No.: 10/572,368

(22) PCT Filed: Apr. 6, 2004
(86) PCT No.: PCT/IT04/00177

§ 371 Date: Mar. 16, 2006

(30) Foreign Application Priority Data
Sep. 18, 2003 (IT) TO2003A000716

(51) Int. Cl. H04K 1/00; G05B 15/00

(52) U.S. Cl. 700/1; 380/247

(57) ABSTRACT

A multi-function portable device for electronic processors including a main support body equipped with an interface for connecting to the electronic processors and with a push button device for sending control signals. A functional device connected to a transmission controller controls the interface. The functional device is adapted to simultaneously perform at least two of the following functionalities: mass storage; cryptography; smart card reading; and SIM card reading.

The present invention refers to a multi-function portable device for electronic processors adapted to be connected to an output port of such processors in order to increase the functionalities available for them.

Various portable devices are known in the art and are adapted to be connected to the USB (Universal Serial Bus) port of a personal computer: they are usually shaped substantially as a parallelepiped, with very small sizes (usually not bigger that a finger of a hand or a common key-holder) and perform one different functionality each, such as mass storage, cryptography, smart card reading, SIM card reading and the like.

Currently there are no commercially available portable devices of this type that contain therein all the above-mentioned functionalities at the same time, and that are able to contain other future functionalities and that are able to be quickly and efficiently connected to any type of processor that can be found on the market.

Object of the present invention is solving the above prior-art problems, by providing a portable device for electronic processors that is of the multi-function type, namely is able to contain therein a whole set of functionalities that can be found on the market only in different devices.

A further object of the present invention is providing a device of the above-mentioned type that allows an easy, immediate and reliable connection to any type of current and future processor.

The above and other objects and advantages of the invention, as will appear from the following description, are obtained by a multi-function device as claimed in claim 1. Preferred embodiments and non-trivial variations of the present invention are claimed in the dependent Claims.

The present invention will be better described by some preferred embodiments thereof, given as a non-limiting example, with reference to the enclosed drawings, in which:

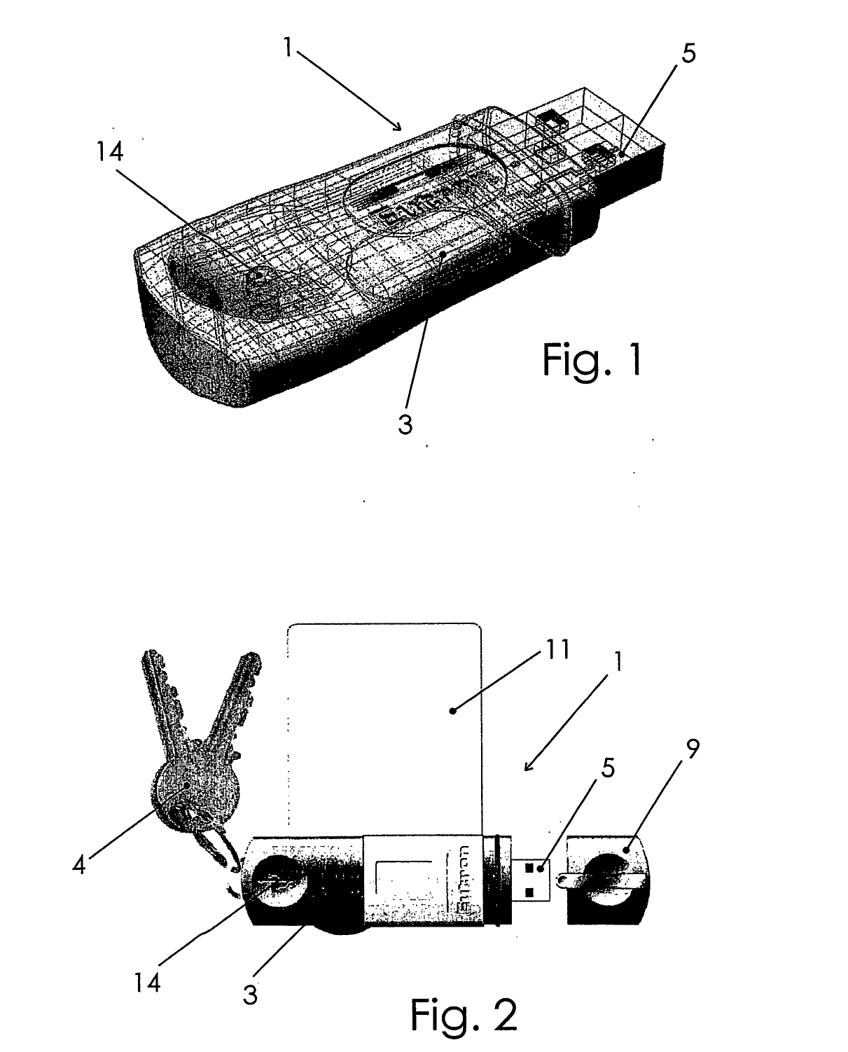

FIG. 1 is an external perspective view of a preferred embodiment of the device according to the present invention;

FIG. 2 is a top view of the device in FIG. 1 in a ready-for-use configuration;

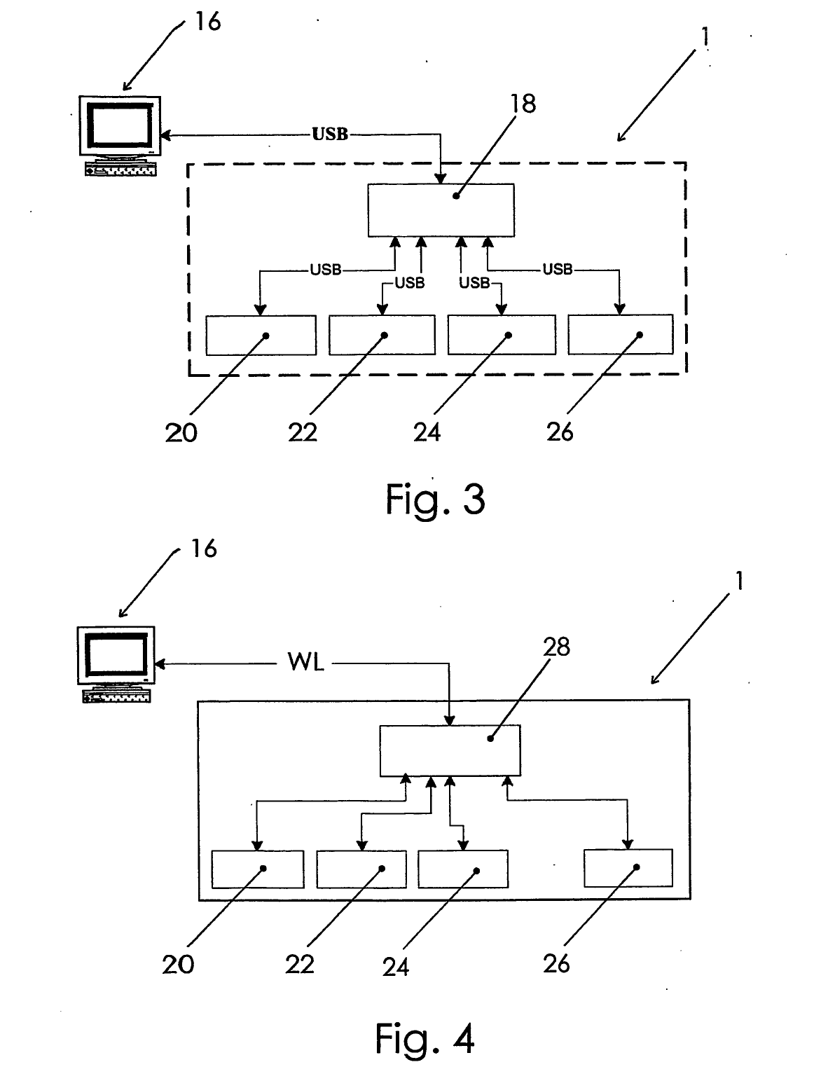

FIG. 3 is a block diagram of the general USB connection architecture of the device of the invention;

FIG. 4 is a block diagram of the connection architecture of the inventive device in a wireless arrangement;

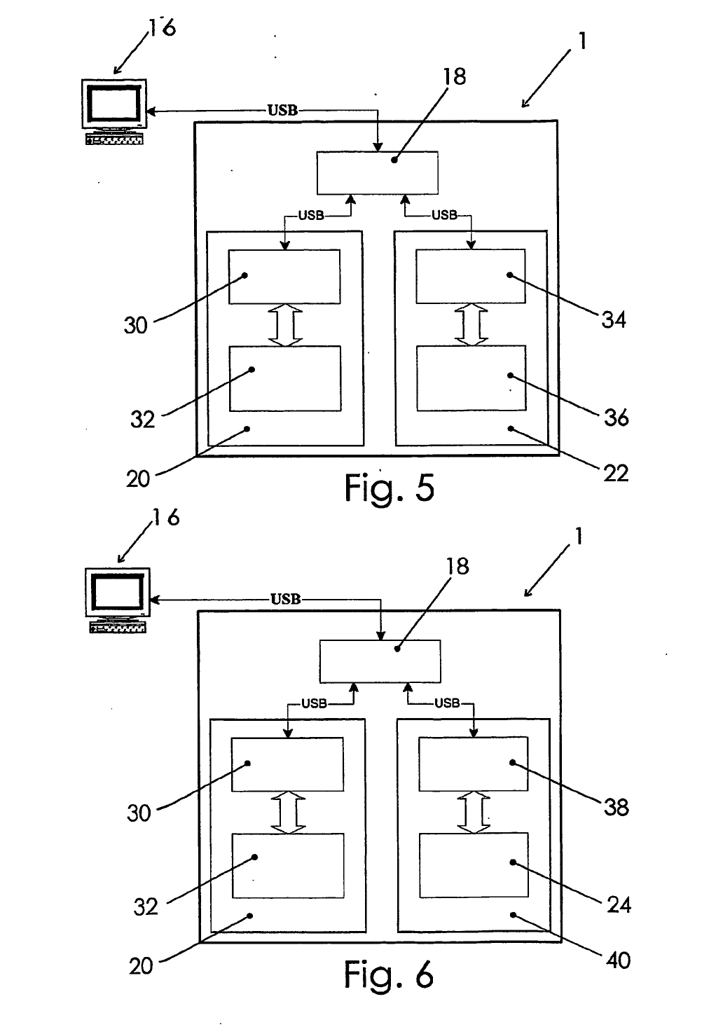

FIG. 5 is a block diagram of the managing architecture for some functionalities of the inventive device;

FIG. 6 is a block diagram of the managing architecture of other functionalities of the inventive device;

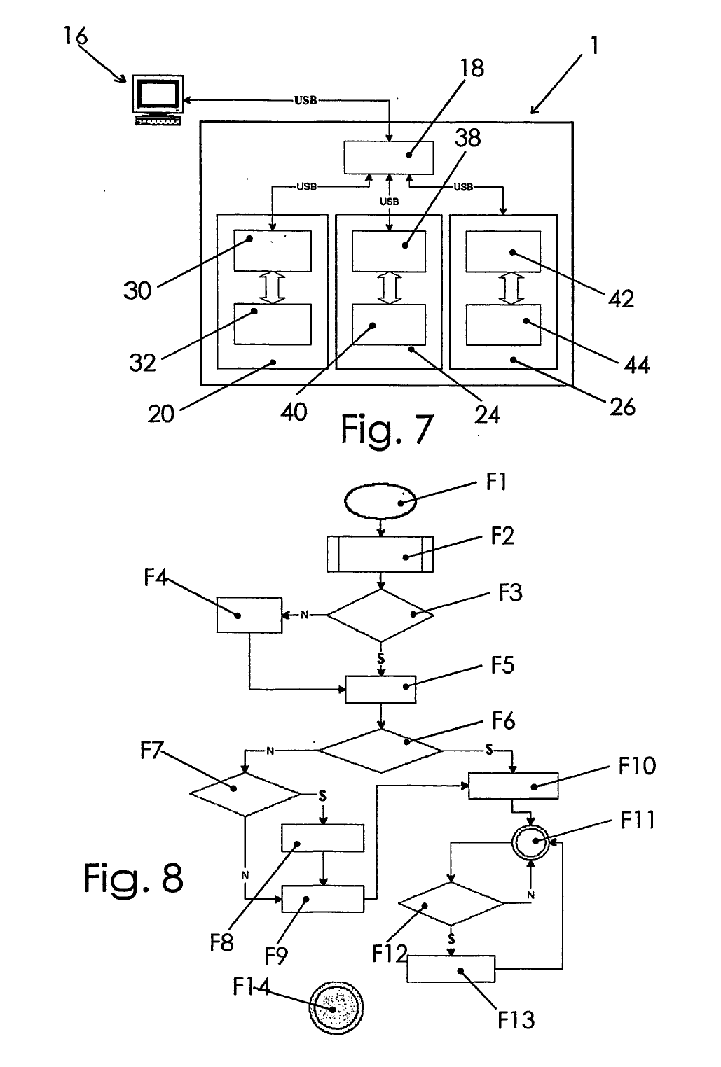

FIG. 7 is a block diagram of the managing architecture of other further functionalities of the inventive device;

FIG. 8 is a flow chart that shows the general operation of the device of the invention;

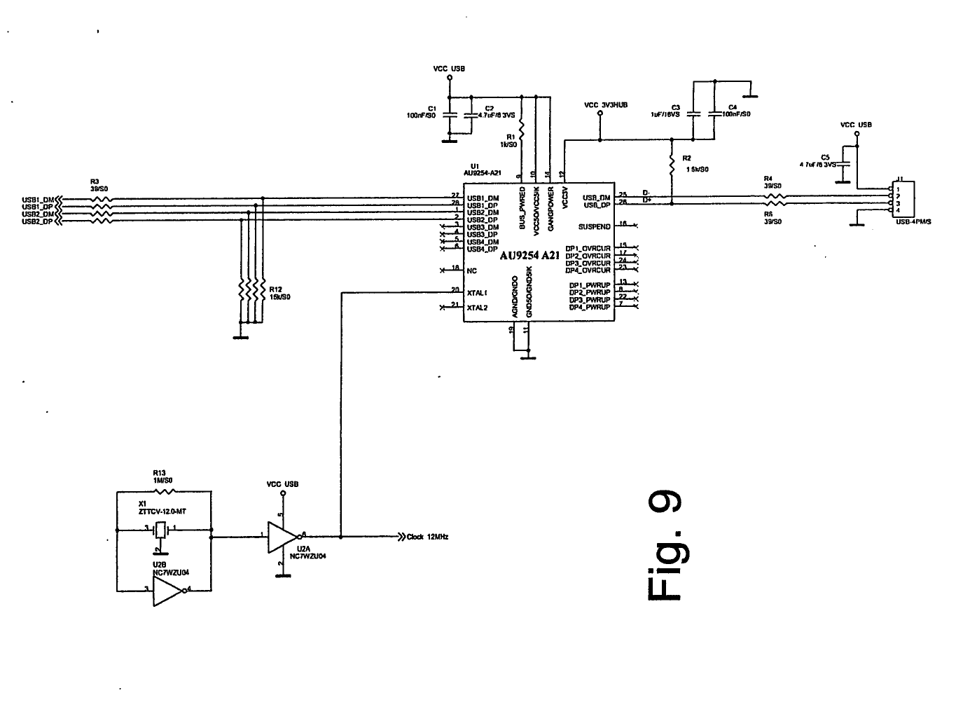

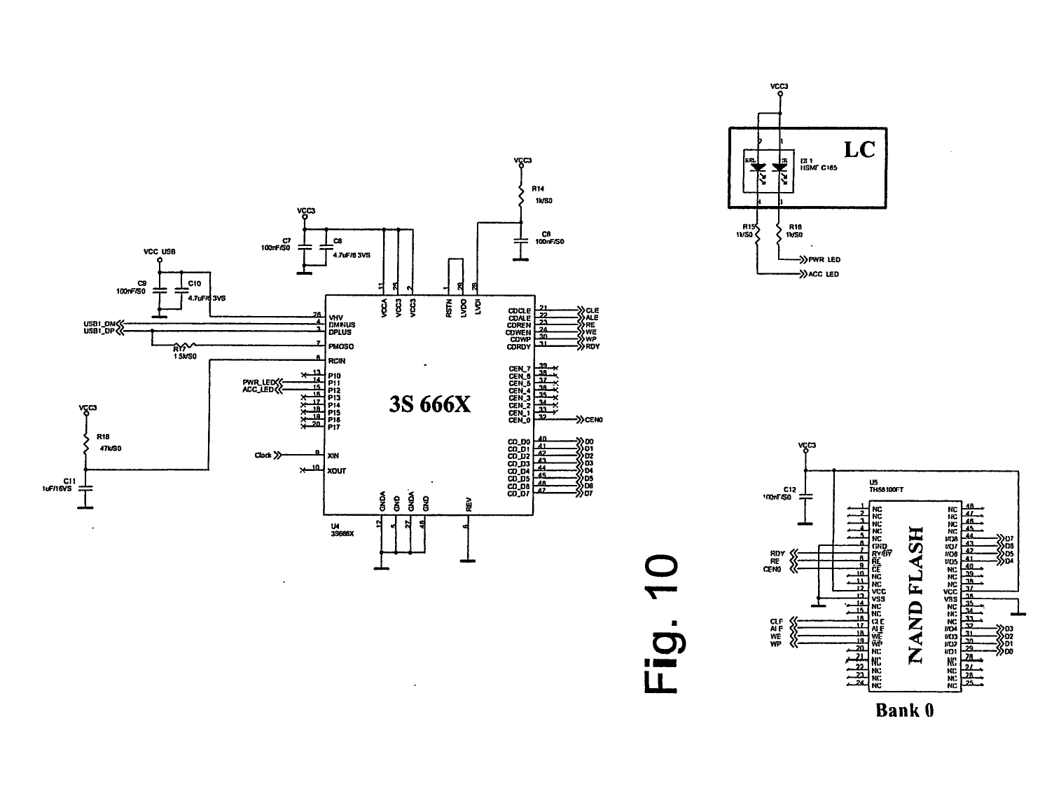

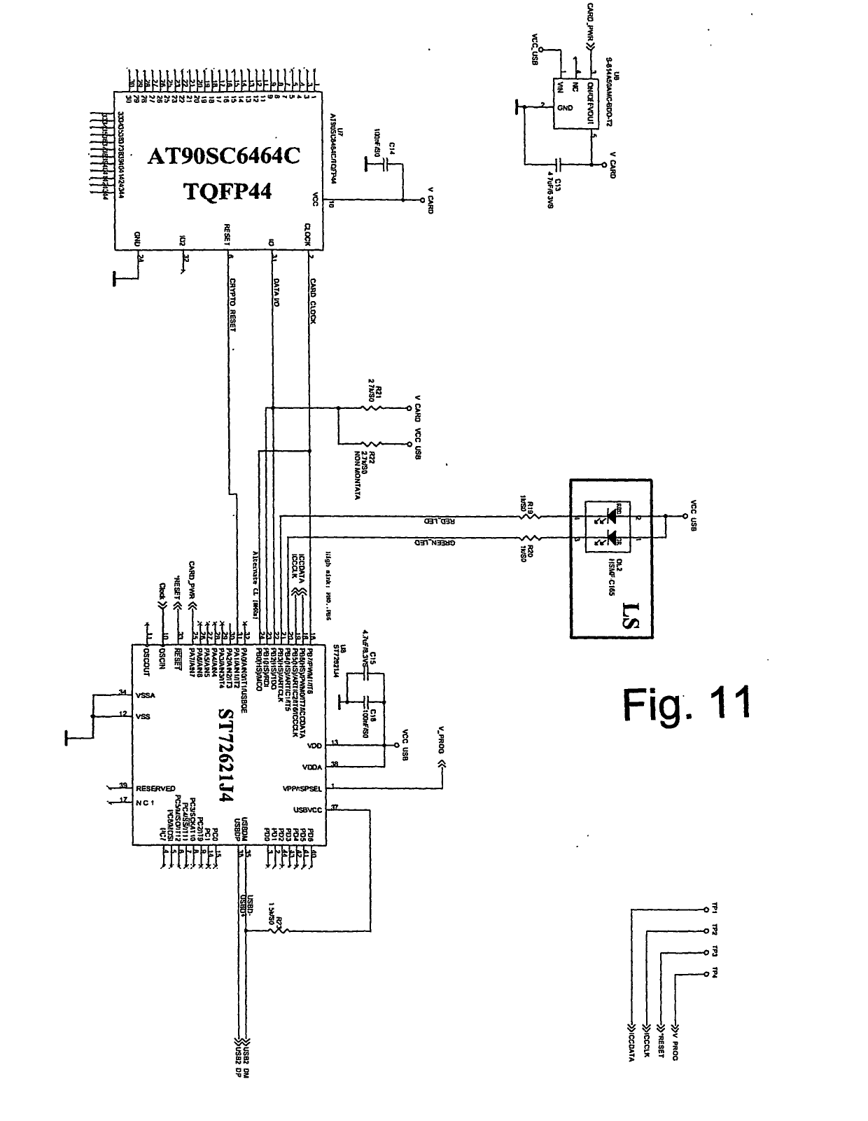

FIGS. 9 to 11 are electric diagrams of the variation of the device shown in FIG. 5;

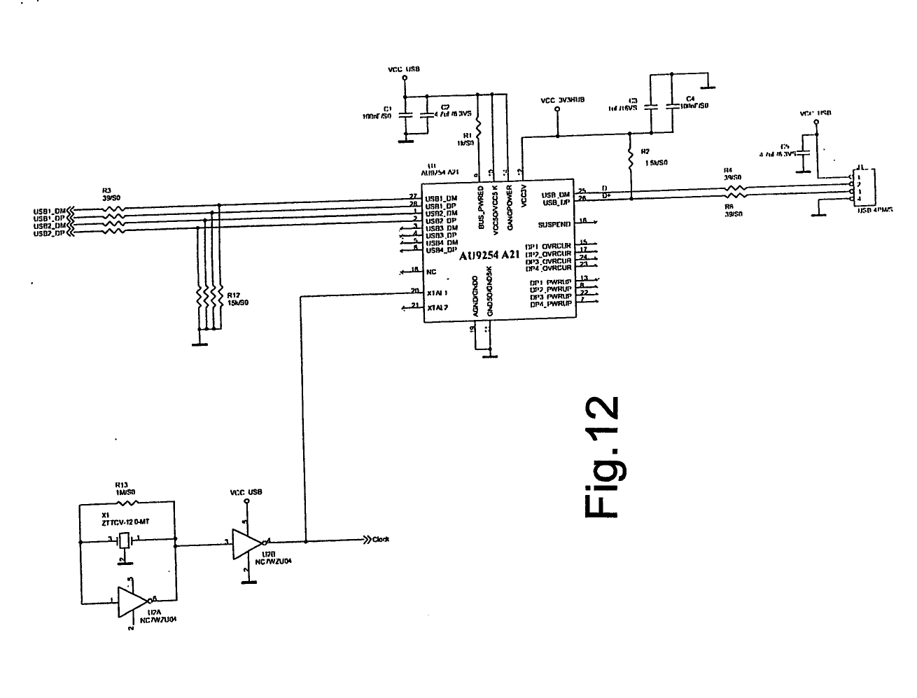

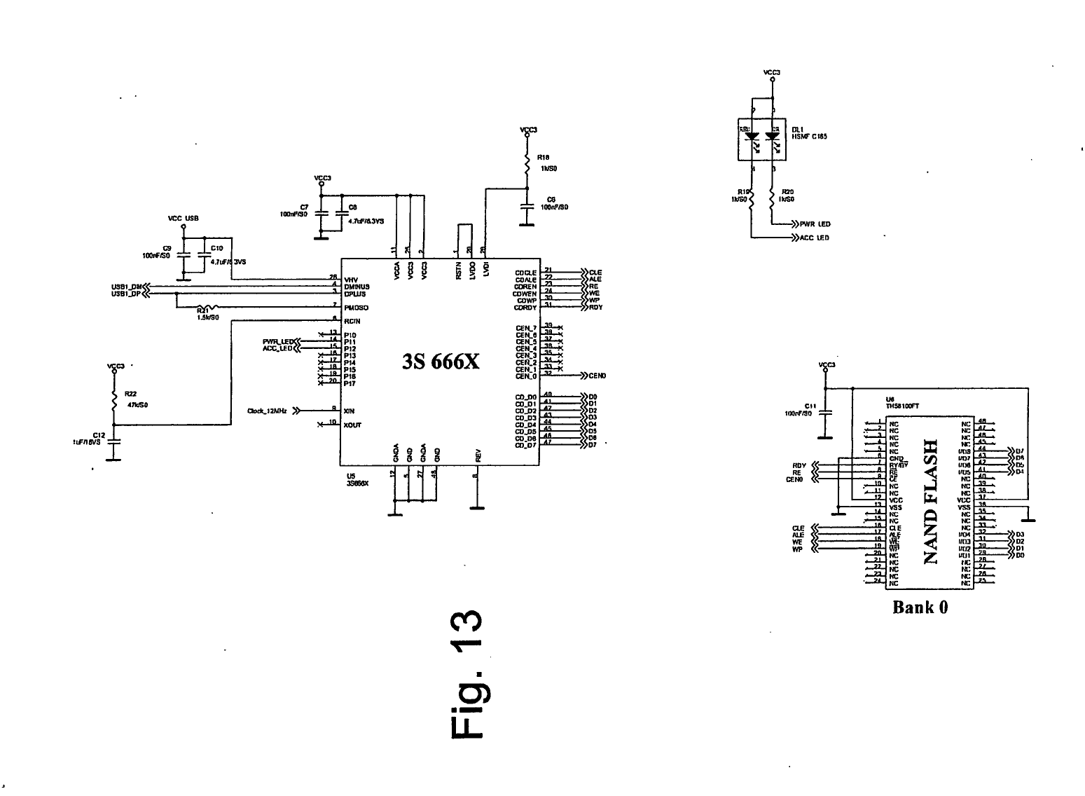

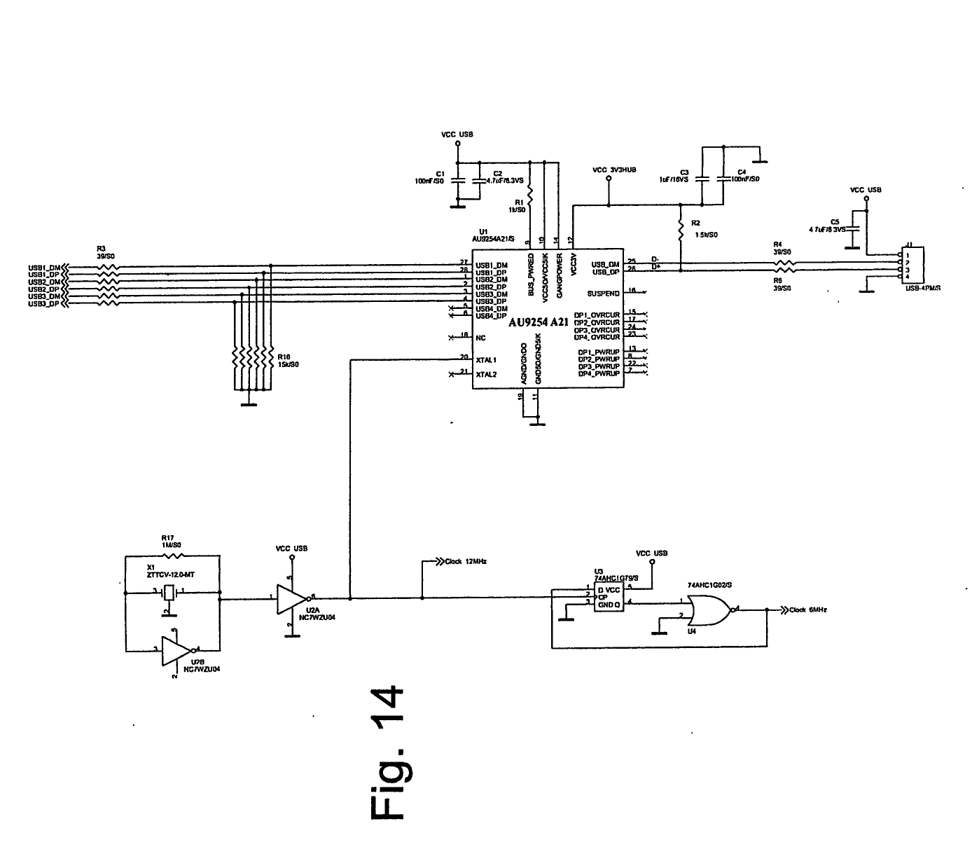

FIGS. 12 to 14 are electric diagrams of the variation of the device shown in FIG. 6; and

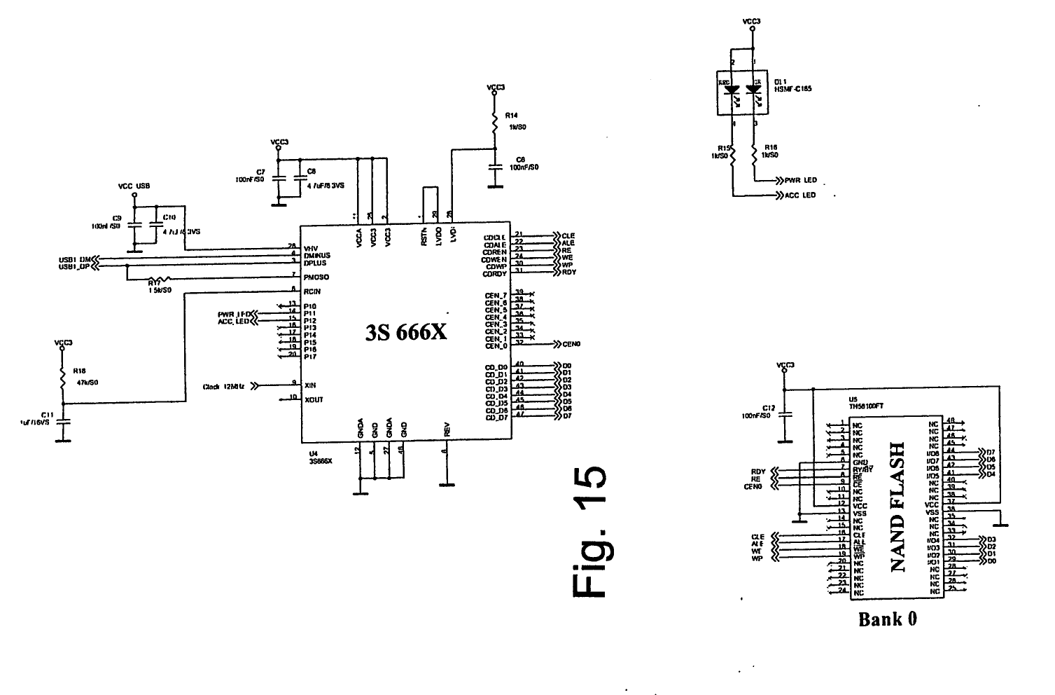

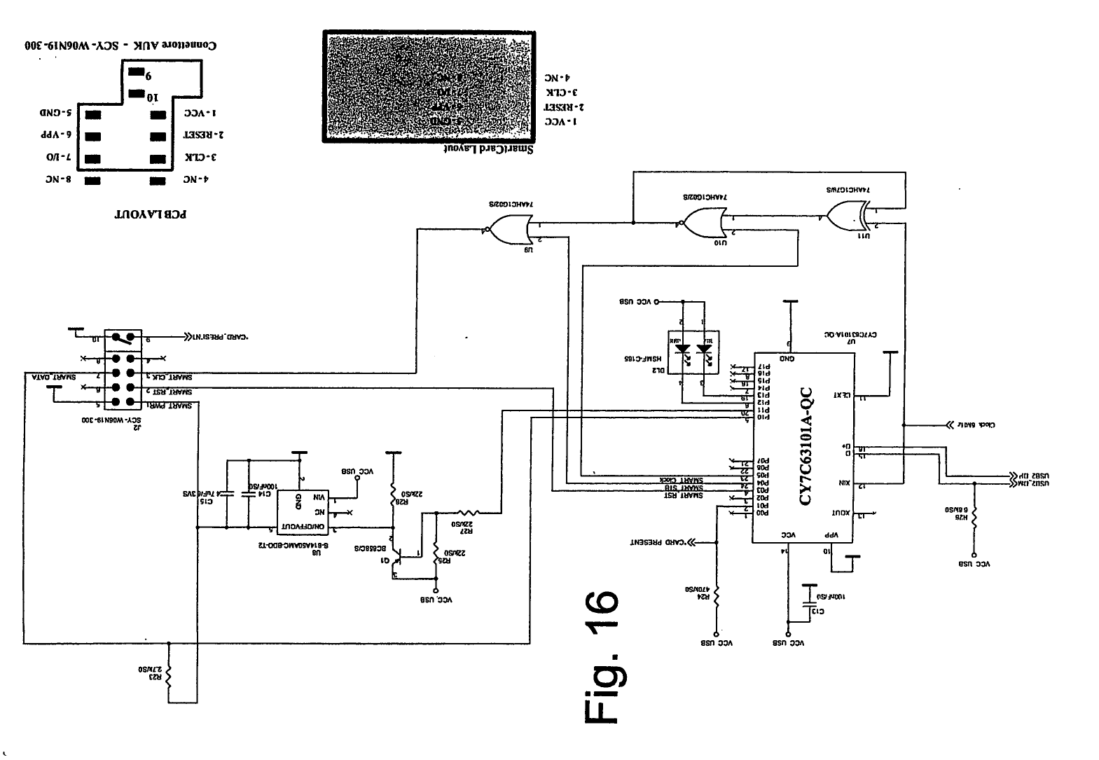

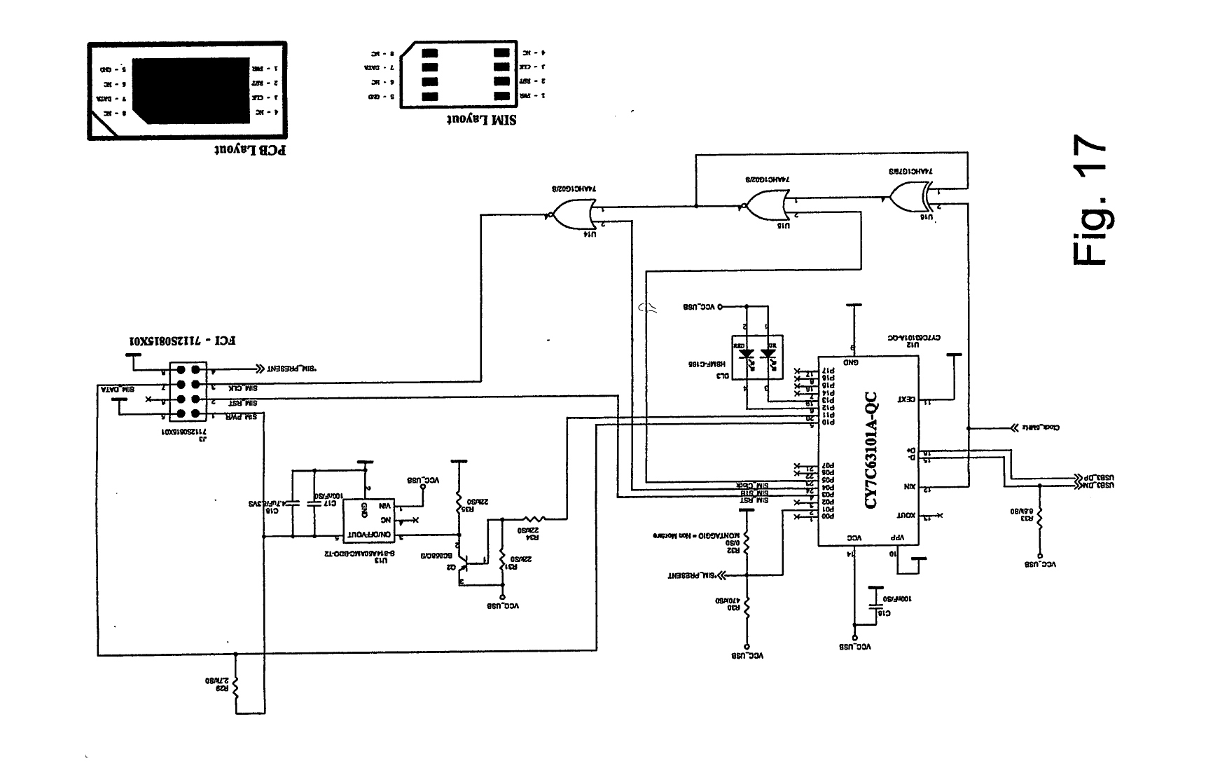

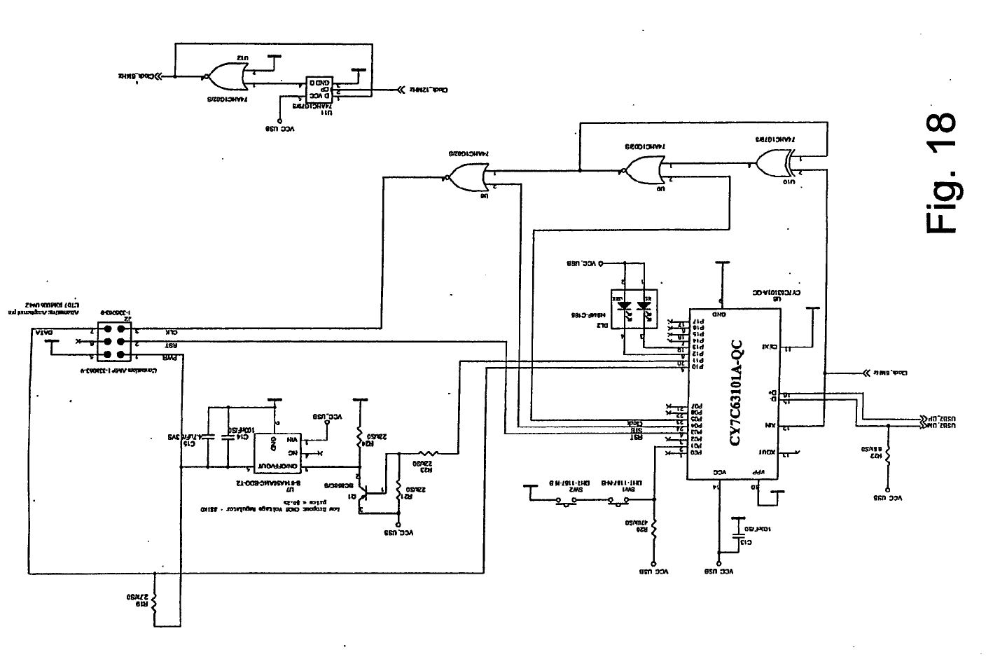

FIGS. 15 to 18 are electric diagrams of the variation of the device shown in FIG. 7.

With reference to the Figures, a preferred embodiment of the multi-function device of the present invention is shown and described. It will be immediately obvious to the skilled people in the art that numerous variations and modifications (for example related to shape, sizes arrangements and parts with equivalent functionalities) could be made to the described device without departing from the scope of the invention as claimed in the enclosed Claims.

Externally, as shown in FIG. 1 and 2, the multi-function device 1 of the invention is realised with a main body 3 whose shape is substantially like a parallelepiped with rounded edges and whose sizes are small, approximately equal to the sizes of a common key-holder (in FIG. 2 keys 4 are shown, connected to the device 1 that can indeed operate also as key-holder).

The main body 3 of the device 1 is equipped at one end with an interface 5 for connecting to a port (in the shown case the USB type port) of a personal computer through which it will be possible to exchange data, programs and information with the computer itself. In a further embodiment (not shown) of the device 1, the interface 5 could be of the wireless type, such as for example of the infrared rays type, or any other interface adapted to communicate with a computer. The device 1 can also comprise a cover element 9 protecting the interface 5.

The device 1, as can be seen in Fig. 2, is adapted to be connected to cards 11, of the smart card type, that are inserted thereinto in order to read their contents and exchange information with the device 1. For such purpose, the device 1 is further equipped with pushbutton means 14 adapted to send, in a known way, a series of control signals for functions of the cryptographic type or for interacting with a smart card.

With these general arrangements, the device 1 of the invention is thereby adapted to contain and perform therein a plurality of functionalities, that were not available before on the market unless through similar, but separate devices.

The main functionalities with which the device 1 of the invention is equipped, separately or in combination, are:
mass storage;
cryptography;
smart card reading;
SIM card reading.

Obviously, due to how the device 1 of the invention is structured, it will always possible to add other functionalities in the future, or create devices 1 with different combinations of the provided functionalities.

FIG. 3 shows the general architecture of the device 1 of the invention, connected to an external processor 16, for example of the host type. It is possible to distinguish in the block diagram in FIG. 3 the main components of the device 1, and namely, first of all, the transmission controller 18: such component enables the communication between host 16 and various functional means 20, 22, 24, 26 etc. implemented inside the device 1, for example through a USB protocol; currently a 4-port USB HUB 18 is used, but, if deemed necessary, the number of ports can be increased up to 32.

It must be noted that currently the USB HUB 18 communicates with the host 16 in a Full-Speed mode, while the various functional means 20, 22, 24, 26 can communicate both in Full-Speed mode and in Low-Speed mode. It can be provided to replace the HUB 18 with a HUB of the High-Speed type and this will allow integrating in the device 1 also functional means that are able to communicate in “High-Speed USB” mode.

As already stated, it is not necessary that all functional means 20, 22, 24, 26, etc. are present: in the current configuration, the functional means range from a minimum of 2 to a maximum of 4, but in future configurations the number of such means can arrive up to 32.

The USB HUB 18 is of the Standard type and therefore it does not need particular drivers. This implies that the recognition from the managing operating system (that could for example be Microsoft Windows 2000® and higher, Linux Kernel 2.4® and higher, MaxOS® and higher) is automatic and completely transparent for the end user.

FIG. 4 shows an architecture that is similar to the one in FIG. 3, in which however the communication with host 16 occurs through a wireless (WL) connection, for which a suitable HUB 28 is provided. In this case, the number of functional means driven by the HUB 28 strongly depends on the computation power of the HUB 28 itself and therefore it cannot be determined a priori.

Some possible practical embodiments of the device 1 of the invention will now be described as a non-limiting example. A first variation of such device 1 is shown in FIG. 5, in which the mass storage and cryptography functionalities are integrated in a single product.

For such purpose, the mass storage functional means 20 comprise a mass storage microcontroller 30 connected to the USB HUB 18 and to a mass storage 32, preferably of the Flash type. In parallel, the cryptography functional means 22 comprise a cryptographic microcontroller 34 (preferably of the ISO7816type) connected to the USB HUB 18 and to a cryptographic chip 36, preferably of the die- or package-type.

FIG. 6, instead, shows the variation of the device 1 that integrates mass storage (already shown in FIG. 5) and smart card reader and/or SIM card reader. For such purpose, in addition to the functional means 20, smart card reading functional means 24 are provided, comprising a smart card reading microcontroller 38 connected to the USB HUB 18 and to a smart card connector or SIM card connector 40.

FIG. 7 instead shows a variation simultaneously containing mass storage, smart card reading and SIM card reading. In addition to the already-described functional means 20 and 24, SIM card reading functional means 26 are provided, comprising a SIM card reading microcontroller 42 connected to the USB HUB 18 and to a SIM card connector 44.

It is obvious that the connections of functional means in FIG. 5 to 7 have been shown as realised towards a USB HUB 18 for a USB-type connection to host 16; the same operating indications are valid in case of wireless connection and wireless HUB 28.

In all configurations shown, and in all other ones that can be derived from possible combinations of the stated functionalities, the processor 6 will recognise the various functional means 20, 22, 24, 26, etc. through suitable drivers being present on the operating system or that are owned by the manufacturers of the different functionalities.

FIG. 8 shows the general operation of the device 1 of the invention.

After the connection (F1), a communication with the host 16 is established (F2) and it is checked (F3) whether HUB 18 or 28 is installed. If the reply is negative, the HUB 18 or 28 itself is installed (F4), while, if the reply is positive, the HUB 18 or 28 is started (F5).

It is then checked (F6) whether the functional means 20, 22, 24, 26, etc. are installed. If the reply is negative, it is checked whether external drivers are necessary (F7) and, if this is the case, the drivers are requested (F8), otherwise the various functional means are installed (F9). If the reply to the check (F6) is positive, the various functional means 20, 22, 24, 26, etc. are started (F10) by placing them in an idle state (F11).

Starting from such state (F11), it is checked whether a functionality request is pending (F12) and if this is the case, such request is processed (F13) in a known way for the different provided functionalities.

The device remains operating under this mode till it is. disconnected (F14).

As final practical example, FIGS. 9 to 11 are electric diagrams that allow realising the variation of the device shown in FIG. 5; FIGS. 12 to 14 are electric diagrams that allow realising the variation of the device shown in FIG. 6; and FIGS. 15 to 18 are electric diagrams that allow realising the variation of the device shown in FIG. 7.

1-12. (canceled)

13. A multi-function portable device for electronic processors, comprising:
a main support body equipped with interface means for connecting to said electronic processors and with pushbutton means for sending control signals; and
functional means connected to a transmission controller that controls said interface means, said functional means being adapted to simultaneously perform at least two of the following functions:
mass storage;
cryptography;
smart card reading;
SIM card reading.

14. A multi-function device according to claim 13, wherein said functional means includes respective processing and control means coupled with respective operating means.

15. A multi-function device according to claim 13, wherein the mass storage functionality is performed through a mass storage microcontroller operatively coupled with the transmission controller and with a mass storage.

16. A multi-function device according to claim 15, wherein said mass storage is a Flash-type memory.

17. A multi-function device according to claim 13, wherein the cryptographic check functionality is performed through a cryptographic checking microcontroller operatively coupled with the transmission controller and with a cryptographic chip.

18. A multi-function device according to claim 17, wherein said cryptographic checking microcontroller is of a IS07816 type.

19. A multi-function device according to claim 17, wherein said cryptographic chip is of die- or package-type.

20. A multi-function device according to claim 13, wherein the smart card reading functionality is performed through a smart card reading microcontroller operatively coupled with the transmission controller and with a smart card connector or SIM card connector.

21. A multi-function device according to claim 13, wherein the SIM card reading functionality is performed through a SIM card reading microcontroller operatively coupled with the transmission controller and with a SIM card connector.

22. A multi-function device according to claim 13, wherein said transmission controller is a controller of a HUB-type for USB.

23. A multi-function device according to claim 13, wherein said transmission controller is a controller of a wireless type.

24. A multi-function device according to claim 23, wherein said wireless transmission controller is of an infrared-ray type.
